(19) United States
(12) Patent Application Publication
(10) Pub. No.: US 2013/0065651 A1
(43) Pub. Date: Mar. 14, 2013

(54) PORTABLE TELEPHONE HAVING A MARKING

(71) Applicants: Benoît Abiven, Cergy Pontoise (FR); Jianping Yang, Ningbo (CN); Qingde Kong, Ningbo (CN)

(72) Inventors: Benoît Abiven, Cergy Pontoise (FR); Jianping Yang, Ningbo (CN); Qingde Kong, Ningbo (CN)

(73) Assignee: OPTION, Leuven (BE)

(21) Appl. No.: 13/578,746

(22) PCT Filed: Feb. 11, 2011
(86) PCT No.: PCT/EP2011/052008

§ 371 Date: Nov. 29, 2012

(30) Foreign Application Priority Data
Feb. 12, 2010 (FR) 10/00598

(51) Int. Cl. H04W 88/02

(52) U.S. Cl. 455/569.1

(57) ABSTRACT

The present invention relates to a mobile phone comprising a casing (11) provided to house the various components of the phone, the said casing (11) being provided in order to receive a window (12), and a loudspeaker (40) mounted on the side of the casing (11) which is opposite to that which receives the window (12), the said phone having a marking (M).

According to the present invention, it comprises a marking system for presenting the said marking (M) which consists of an opening (121) formed in the window (12) and a projection (111) on the casing (11) in a general form of marking (M) and provided to pass inside of the opening (121), and in that the said loudspeaker (40) is mounted in line with the marking system, transmission means being provided to enable sound waves emitted by the said loudspeaker (40) to be transmitted by the said opening (121).

The present invention relates to a mobile phone that is provided with a marking, for example representative of the brand of the said phone, or the operator used by the said phone, or other.

More particularly, the present invention relates to a mobile phone which is essentially composed of a casing provided to house the various components of the phone and to be able to receive either on the front side of the phone or on back side, a window. Among the components of the phone housed in the casing, is the loudspeaker which is generally mounted on the said casing, on the side of the casing which is opposite to that which has the window.

Usually, the marking with which the phone is provided is printed or screen-printed either on the window of the phone or on the back of the casing. The result is ultimately ordinary in terms of aesthetic and it may happen that, over time, this type of marking deteriorates or disappears. For example, the marking becomes dirty, becomes patinated, loses its colour, etc . . . Moreover, in the manufacturing process of the phone, it requires the provision of one or more special operations only for this marking

We, therefore, look for a solution to these problems and means that allow the presentation of the marking in a unique and aesthetic manner and that avoids having to use special manufacturing operations for this marking.

For this purpose, a mobile phone according to the present invention is characterized in that it comprises a marking system for presenting the said marking which comprises an opening made in the window and a projection on the casing having the general shape of the marking and intended to protrude into the said opening, and in that the said loudspeaker is mounted in line with the marking system, transmission means being provided to allow sound waves emitted by the said loudspeaker to be transmitted through the said opening.

Thus, the marking obtained is not printed or screen-printed so it does not deteriorate over time. Furthermore, it requires no additional operations in the manufacturing process of the phone since the projection is obtained during moulding of the casing (only the mould must be modified) and since the opening of the window is already provided for the passage of sound waves from the loudspeaker.

Advantageously, the wall of the said opening has a shape such that it takes on, at a certain distance, the shape of the marking.

Advantageously, the said transmission means consist of holes provided in the casing in line with the opening on the side of the marking.

Advantageously, the said casing is made of plastic, the said projection having at least its front side metallized.

Advantageously, the said window is mounted on the front face side of the said casing of the said phone.

The aspects of the invention mentioned above, as well as others, will become more apparent upon reading the following description of an exemplary embodiment, the said description being given in relation to the attached drawings, among which:

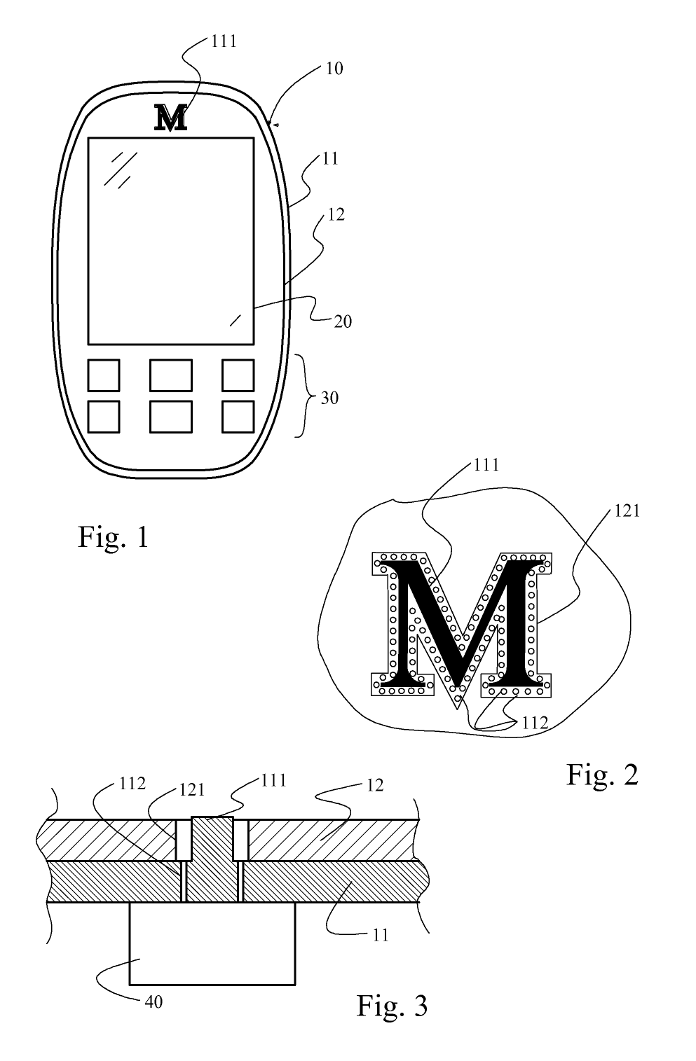

FIG. 1 is a drawing of a mobile phone equipped with a marking system according to the present invention,

FIG. 2 is an enlarged front view of a mobile phone according to the present invention in relation to its marking system, and

FIG. 3 is a sectional view of the marking system of a mobile phone according to the present invention.

The mobile phone shown in FIG. 1 is essentially constituted by a casing 11 on which a touch screen 20 is mounted for the display of various information and also to enter commands. On the said casing 11, a set of keys or keyboard 30 can also be mounted permitting the triggering of various functions of the said phone such as dialling, taking or breaking the line, displaying a phone list in order of dialling a recipient selected from the said phone list, etc. The number of keys represented here is six but it will be understood that it could be completely different without thereby affecting the present invention.

The casing 11 is provided to accommodate the various components of the phone. It is also provided to receive a window 12 and, to this end, it is for example provided with a shoulder.

In some embodiments, the window 12 is mounted on the front face of the casing 11. The front side being the side, from which the screen 20 is visible, this window 12 is, in these embodiments, either a protective window of the screen 20, or an integral part of the touch screen 20. For example, the casing 11 comprises a shoulder on its front side.

In other embodiments, the window 12 is mounted on the back side of the casing 11. The back side being the side opposite to the side from which the screen 20 is visible, the window 12 is, in these embodiments, a protective window. This is the back side of the casing 11 which, for example, then comprises a shoulder.

On the housing 10 formed by the casing 11 and the window 12, there is provided a marking M, for example representative of the brand of the said phone, or the operator used by the said phone, or other.

As can be seen in FIG. 3, the marking system for the presentation of the marking M according to the present invention comprises an opening 121 which is formed in the window 12 and the wall of which advantageously has a shape such that it takes on, at a certain distance, varying from 0.2 to 1 mm, the shape of the marking M. In FIG. 2, one can see the outer periphery of the opening 121 that takes on, to a certain distance, the marking M.

The marking M comprises a projection 111, having the general shape of the marking M and provided to protrude into the opening 121 so that its front side is substantially levelled with the front side of the window 12.

According to the present invention, the loudspeaker 40 of the said phone is mounted on the side of the casing 11 which is opposite to that which receives the window 12 and is in line with the marking system. In order to transmit sound waves towards the outside the phone, means of transmission, such as holes 112 are provided in the casing 11 in line with the opening 121 on the side of the marking M. We can see in FIG. 2 holes 112 which open into the space between the marking M and the wall of the opening 121, these holes 112 forming the said means.

According to one embodiment of the present invention, the casing 11 is metallic, e.g. in aluminium.

In another embodiment, the casing 11 is made of plastic and the protrusion 111 provided on the casing 11 is metalized.

1. A mobile phone comprising a casing provided to house the various components of the phone, the said casing being provided for receiving a window, and a loudspeaker mounted on the side of the casing which is opposite to that which receives the window, the said phone having a marking (M), the said phone further comprising a marking system for presenting the said marking (M) which comprises a projection on the casing having the general shape of the marking (M), the said loudspeaker being mounted in line with the marking system, characterized in that the marking system is further comprised of an opening formed in the window, in that the said projection is provided to protrude into the opening, and in that transmission means are provided to enable the sound waves emitted by the said loudspeaker to be transmitted through the said opening.

2. The portable phone according to claim 1, characterized in that the wall of the said opening has a shape such that it takes on, at a certain distance, the shape of the marking (M).

3. The portable phone according to claim 1, characterized in that the said transmission means are formed by holes provided in the casing in line with the opening, on the side of the marking (M).

4. The portable phone according to claim 1, characterized in that the said casing is made of plastic, the said projection having at least its front side metalized.

5. The portable phone according to claim 1, characterized in that the said window is mounted on the front side of the said casing of the said phone
